(19) United States
(12) Patent Application Publication
(10) Pub. No.: US 2014/0073258 A1
(43) Pub. Date: Mar. 13, 2014

(54) System and Method of Adaptive Out-of-Band Interference Cancellation for Coexistence

(71) Applicant: Apple Inc., Cupertino, CA (US)

(72) Inventors: William Burchill, San Jose, CA (US); Syed A. Mujtaba, Santa Clara, CA (US)

(73) Assignee: Apple Inc., Cupertino, CA (US)

(21) Appl. No.: 14/011,948

(22) Filed: Aug. 28, 2013

Related U.S. Application Data
(60) Provisional application No. 61/698,530, filed on Sep. 7, 2012.

(51) Int. Cl. H04B 1/12

(52) U.S. Cl. CPC H04B 1/12
USPC 455/63.1

(57) ABSTRACT

Adaptive cancellation of out-of-band interference between coexisting wireless communication devices. A signal including out-of-band noise may be received by a victim communication device and by an adaptive cancellation device. The adaptive cancellation device may use an adaptive filter to isolate a representation of the out-of-band noise. The adaptive cancellation device may then subtract the noise from the receive path of the victim communication device. The victim device and the adaptive cancellation device need not be located on the same chip as an aggressor device generating the out-of-band noise.

### FIELD

The present application relates to wireless devices, and more particularly to cancelling signal interference in wireless communications.

### DESCRIPTION OF THE RELATED ART

Modern wireless user equipment devices (“UEs”) frequently incorporate multiple wireless technologies which must coexist. Examples include: cellular (e.g. GSM, CDMA, WCDMA, TDSCDMA, LTE); Bluetooth™; Wi-Fi™; and GPS or GNSS.

Due to the imperfections of practical components, including non-ideal filters and nonlinearities in the transmit path, it is a common problem that undesired energy from a first wireless transmission (such as cellular) appears in the receive path of a second wireless technology (such as Bluetooth), causing impaired reception (“desense”) of the second wireless technology. Throughout this disclosure, any such undesired energy outside of the desired frequency range of the first wireless transmission is referred to as out-of-band (“OOB”) noise. It is common to call the technology experiencing desense the “victim,” and the technology causing the desense the “aggressor.”

For example, cellular communications in 3GPP band 40 (2300-2400 MHz) and 3GPP band 7 (2500-2570 MHz) must coexist with communications in the adjacent ISM 2.4 GHz band, such as Bluetooth (2402-2480 MHz) and Wi-Fi (2400-2483.3 MHz). Due to the limitations of practical components, in particular 3rd and 5th order intermodulation nonlinearities, cellular transmissions in bands 40 and 7 generate OOB noise which interferes with reception in the adjacent ISM band. The undesired energy which bleeds into the ISM band is orders of magnitude larger than the desired receive sensitivities in the ISM band. Consequently they can be severely desensed.

As another example, a cellular transmission from BC10 can encounter a third-order nonlinearity (specifically, a third-order harmonic distortion) and put undesired energy in the ISM band, desensing both Bluetooth and Wi-Fi. By way of illustration, a BC10 cellular transmission with a frequency of 807.25 MHz can encounter a third-order nonlinearity and put undesired energy at 2421.75 MHz, which falls within the ISM band.

As yet another example, a cellular transmission in 3GPP Band 13 can encounter a second-order nonlinearity (specifically, a second-order harmonic distortion) and fall very close to the GPS band. By way of illustration, a 3GPP Band 13 cellular transmission with a frequency of 787 MHz can encounter a second-order nonlinearity and put undesired energy at at 1574 MHz, which falls very close to the GPS band center frequency of 1575.42 MHz.

### SUMMARY

In order to facilitate coexistence of multiple wireless technologies within a UE, among other benefits, embodiments are presented herein of a system and method for reducing OOB interference. In particular, a UE may include a system of adaptively estimating and canceling the undesired aggressor power from the victim's receive path.

For example, a UE may include a system that receives from the aggressor device an attenuated copy of the Tx signal including OOB noise, extracts that portion of OOB noise which is to be canceled, translates the OOB noise to baseband, and converts the OOB noise signal to a digital representation of the OOB noise signal. The system may then filter the digital representation of the OOB noise signal using an adaptive filter. The system may receive from the victim device a digital representation of the victim's Rx signal, including OOB noise. The system may then subtract the digital representation of the OOB noise signal from the digital representation of the victim's Rx signal, producing a clean digital representation of the Rx signal, with reduced or eliminated OOB noise. This clean digital representation of the Rx signal may be provided as a feedback input to the adaptive filter and to the victim device for further processing.

In one embodiment, the system may be a standalone chip (i.e. a separate integrated circuit, such as a silicon chip), which receives inputs at least from both the aggressor device and the victim device, and which provides at least an output to the victim device.

In another embodiment, the system may be integrated into a chip with the victim device, which receives inputs at least from the aggressor device.

The presented system and method provide at least the advantages that OOB interference from an aggressor device to a victim device can be cancelled without requiring precision or high-performance components, and without requiring access to the digital baseband signal of the aggressor device. This allows cancellation of OOB noise without requiring co-integration of the aggressor device and the victim device into a single chip.

### BRIEF DESCRIPTION OF THE DRAWINGS

A better understanding of the present invention can be obtained when the following detailed description of the embodiments is considered in conjunction with the following drawings.

FIG. 1 illustrates an exemplary wireless communication system;

FIG. 2 is an example block diagram of a UE 106;

FIG. 3 is an example block diagram illustrating a system for performing adaptive OOB interference cancellation between two wireless communication circuits;

FIG. 4 illustrates power spectra representing signal pulses at various points within a system for performing adaptive OOB interference cancellation;

FIG. 5 is an example block diagram illustrating a system for performing adaptive OOB interface cancellation embodied on a stand-alone chip 250; and

FIG. 6 is an example block diagram illustrating a system for performing adaptive OOB interface cancellation integrated into a chip with a victim device 230A.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the present disclosure as defined by the appended claims.

### DETAILED DESCRIPTION

### Acronyms

The following acronyms are used in the present Patent Application:

LTE: Long Term Evolution

CDMA: Code Division Multiple Access

WCDMA: Wideband Code Division Multiple Access

TDSCDMA: Time Division Synchronous Code Division Multiple Access

GSM: Global System for Mobile communications

GPS: Global Positioning System

GNSS: Global Navigation Satellite System

Tx: Transmission or Transmit

Rx: Reception or Receive

OOB: Out-of-Band

ISM: Industrial, Scientific, and Medical

3GPP: 3rd Generation Partnership Project

BC10: Band Class 10

FIR: Finite Impulse Response

LPF: Low Pass Filter

BPF: Band Pass Filter

LNA: Low-Noise Amplifier

LO: Low-frequency Oscillation

AGC: Automatic Gain Control

A/D: Analog to Digital

D/A: Digital to Analog

PA: Power Amplifier

BB: Baseband

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer over a network, such as the Internet. In the latter instance, the second computer system may provide program instructions to the first computer system for execution. The term “memory medium” may include two or more memory mediums which may reside in different locations, e.g., in different computer systems that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation,

network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DSTM, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station (BS)—The term “Base Station” has the full breadth of its ordinary meaning, and at least includes a wireless communication station installed at a fixed location and used to communicate as part of a wireless telephone system or radio system.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

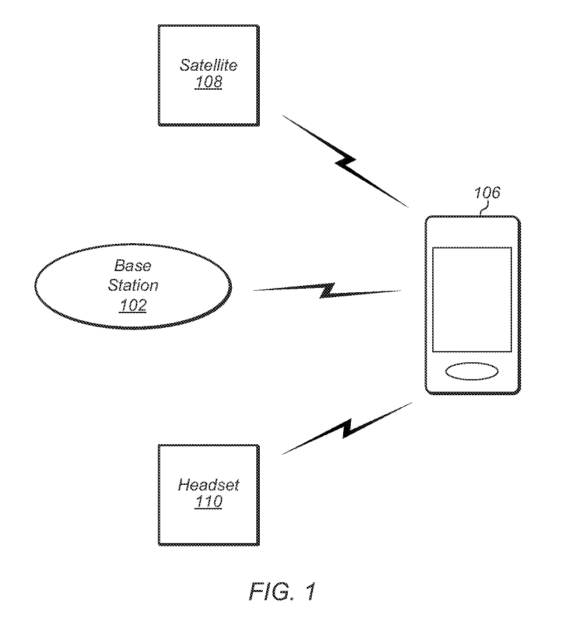

### FIG. 1—Communication System

FIG. 1 illustrates an exemplary (and simplified) wireless communication system. It is noted that the system of FIG. 1 is merely one example of a possible system, and embodiments of the disclosure may be implemented in any of various systems, as desired.

As shown, the exemplary wireless communication system includes a User Equipment (UE) (or “UE device”) 106, which communicates over a transmission medium with a base station 102, using any of various wireless communication technologies such as GSM, CDMA, WCDMA, TDSCDMA, LTE, Wi-Fi™, etc. The UE 106 may also communicate over a transmission medium with satellite 108, using any of various wireless communication technologies such as GPS, GNSS, etc. The UE 106 may also communicate over a transmission medium with various peripheral devices, such as headset 110, using any of various wireless communication technologies such as Bluetooth™, etc.

The UE 106 may be a device with wireless network connectivity such as a mobile phone, a hand-held device, a computer or a tablet, or virtually any type of wireless device. The UE 106 may include a processor that is configured to execute program instructions stored in memory. The UE may perform any of the embodiments described herein by executing such stored instructions. In some embodiments, the UE may include a programmable hardware element such as an FPGA (field-programmable gate array) that is configured to perform any of the method embodiments described herein, or any portion of any of the method embodiments described herein.

In some embodiments, the UE 106 may be configured to perform adaptive OOB interference cancellation, for example as further described subsequently herein.

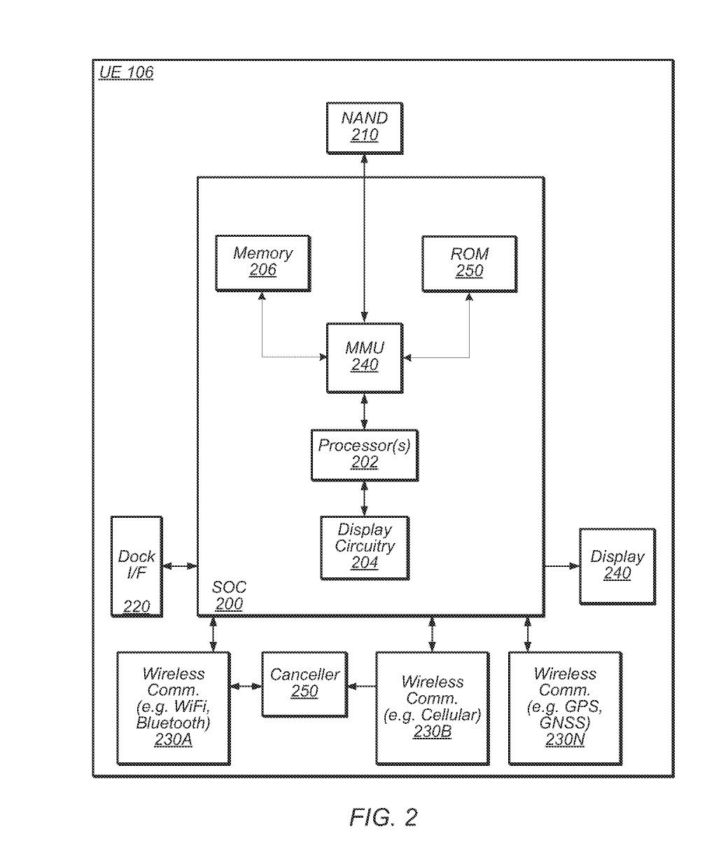

### FIG. 2—Exemplary Block Diagram of a UE

FIG. 2 illustrates an exemplary block diagram of a UE 106. As shown, the UE 106 may include a system on chip (SOC) 200, which may include portions for various purposes. For example, as shown, the SOC 200 may include processor(s) 202 which may execute program instructions for the UE 106 and display circuitry 204 which may perform graphics processing and provide display signals to the display 240. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, radios 230, connector I/F 220, and/or display 240. The MMU 240 may be configured to perform memory protection and page table translation or set up. In some embodiments, the MMU 240 may be included as a portion of the processor(s) 202.

As also shown, the SOC 200 may be coupled to various other circuits of the UE 106. For example, the UE 106 may include various types of memory (e.g., including NAND flash 210); a connector interface 220 (e.g., for coupling to the computer system); the display 240; and wireless communication devices 230A through 230N, each of which may include circuitry and optionally one or more antennas for wireless communications according to one or more wireless communication technologies (e.g. GSM, CDMA, WCDMA, TDSCDMA, LTE, Bluetooth™, Wi-Fi™, GPS, GNSS).

As also shown, the UE 106 may include canceller 250, configured to perform adaptive OOB interference cancellation. For example, canceller 250 may be configured to remove cellular power appearing in the receive path of victim wireless communication device 230A, which cellular power results from OOB noise in a Tx signal radiated by aggressor wireless communication device 230B. Alternatively, some or all of the wireless communication devices 230A through 230N may be configured to perform adaptive OOB interference cancellation, for example as further described subsequently herein.

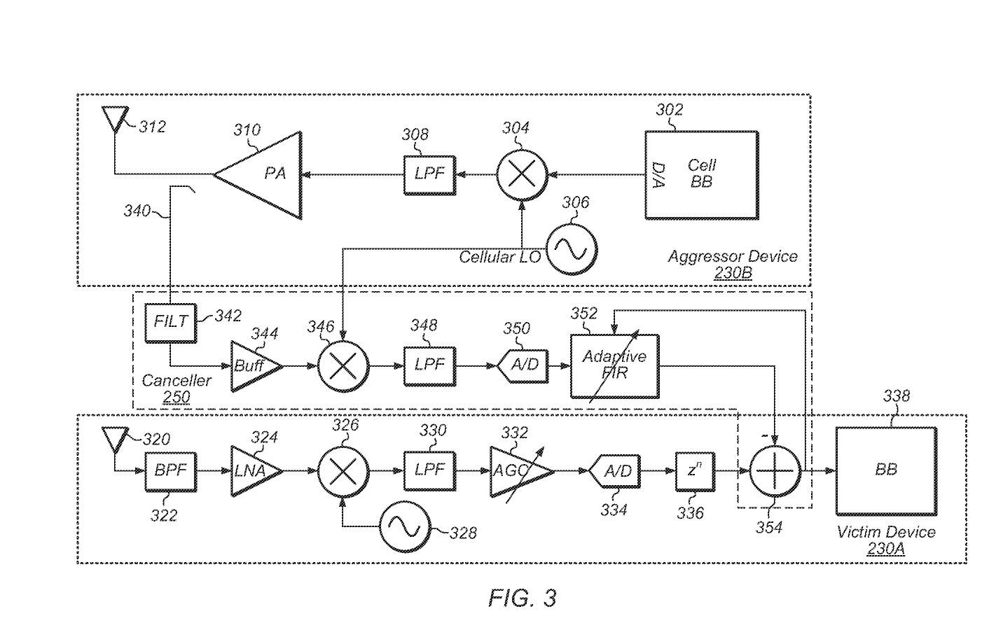

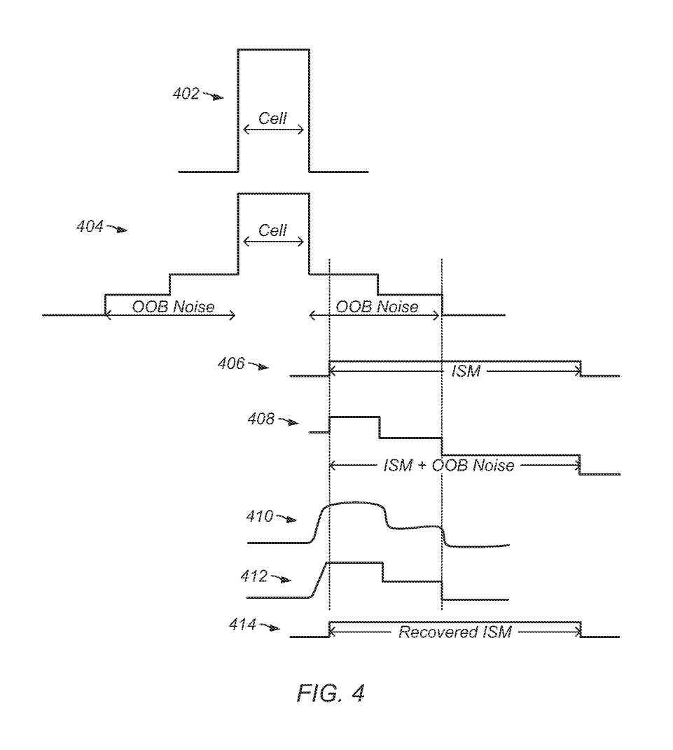

### FIGS. 3 and 4—Adaptive OOB Interference Canceller and Associated Power Spectra

FIG. 3 is an exemplary block diagram of the canceller 250, configured to cancel interference in the Rx path of the victim wireless communication device 230A, which is caused by OOB noise from the aggressor wireless communication device 230B. It is noted that the system of FIG. 3 is merely one example of a possible system for adaptive cancellation of OOB interference.

FIG. 4 illustrates power spectra representing signal pulses at various points within the canceller 250.

The aggressor device 230B is illustrated as a conventional zero-IF (intermediate frequency) architecture for a cellular transmitter, although it is noted that the architecture of the aggressor device is not essential to the present disclosure. As shown, a standard cellular chip or chipset 302 generates baseband (“BB”) analog signals. These are applied to a mixer 304 driven by a suitable low-frequency oscillator (“LO”) 306 to obtain the desired center frequency for the cellular transmission. A lowpass filter (“LPF”) 308 (or alternatively a bandpass filter (“BPF”)) cleans up some harmonic components. The power spectra of the output signal from the LPF 308 is ideally very clean and confined to the intended cellular band, as represented by pulse 402. Due to nonlinearities of a power amplifier (“PA”) 310 (and in some cases solid-state switches and filters), undesired OOB noise is generated and present at the output of the PA 310, as represented by pulse 404.

The victim device 230A is illustrated as a standard ISM band receiver, which is an adequate receiver when there are no coexisting cellular transmissions. The ISM band signal is selected by a BPF 322 following an Rx antenna 320. A low-noise amplifier (“LNA”) 324 raises the signal level to one suitable for a mixer 326, which is driven by a suitable LO 328 to translate the ISM signal down to baseband. A LPF 330 cleans up some harmonics and an automatic gain control (“AGC”) 332 optimizes the signal level for analog-to-digital (“A/D”) conversion by an A/D converter 334. In a conventional design, the output of the A/D converter 334 is then applied to a standard communication protocol (e.g. Bluetooth™, WiFi™) chip or chipset 338 to recover the communication signal. Pulse 406 represents the desired ISM receive power spectra at the output of the A/D converter 334 without noise from cellular transmissions. Pulse 408, by contrast, represents the actual receive power spectra in the ISM band when OOB noise from cellular transmissions is present at the output of the A/D converter 334.

Unavoidable coupling from a cellular Tx antenna 312 to the ISM band Rx antenna 320 causes the cellular OOB noise to be added to the ISM band receive signal. The canceller 250 performs adaptive cancellation of this OOB noise to allow coexistence of the aggressor device 230B and the victim device 230A, for example as follows.

A coupler 340 picks up an attenuated copy of the Tx signal, and a filter 342 extracts that portion of OOB noise which is to be canceled. A buffer 344 may be included at this stage. Pulse 410 represents the power spectra of the approximate recovery of OOB noise at the output of the buffer 344. A mixer 346 uses the same LO 306 as the aggressor device 230B, translating the OOB noise to baseband. A LPF 348 removes some mixer harmonics, and an A/D converter 350 converts the signal to a digital representation of the translated OOB noise.

An adaptive filter 352 takes as inputs the output of the A/D converter 350 and the output of a subtractor 354. The adaptive filter 352 is preferably an adaptive finite-impulse response (“FIR”) filter. Feeding back the output of the subtractor 354 as an input to the adaptive filter 352 produces a more accurate baseband replica of the OOB noise at the output of the adaptive filter 352. Pulse 412 represents the power spectra of the accurate model of the OOB noise at the output of the adaptive filter 352. The accurate model of the OOB noise output by the adaptive filter 352 is subtracted from the ISM band signal output by the A/D converter 334 by the subtractor 354. The output of the A/D converter 334 may be delayed, as necessary, by a digital delay line 336. The output of the subtractor 354 is a clean ISM band signal, as represented by pulse 414, which is applied to the communication protocol chip or chipset 338.

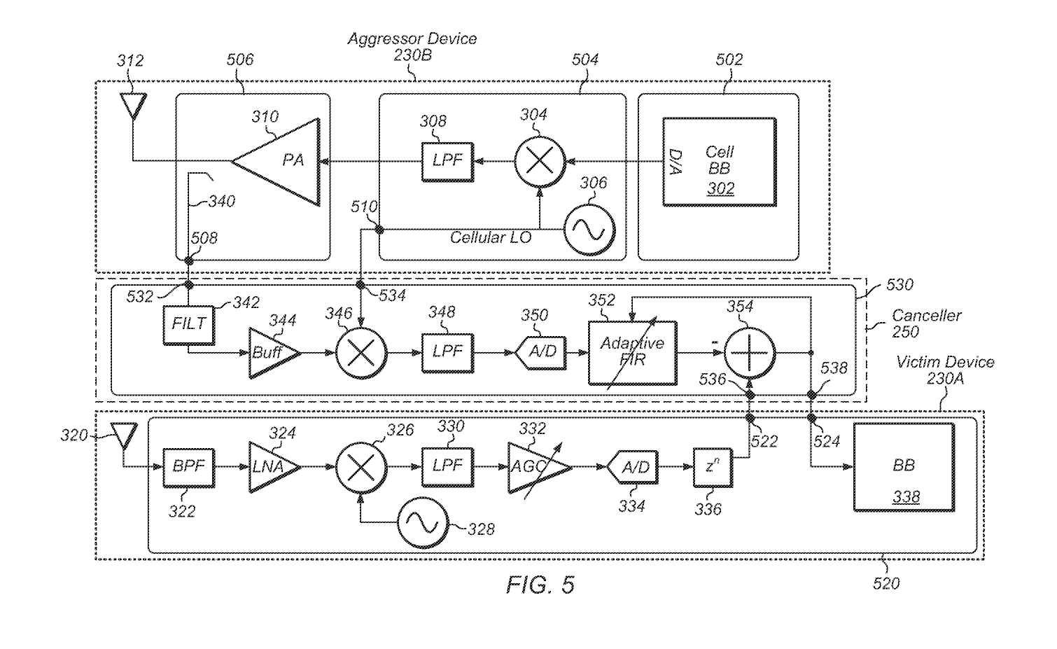

### FIG. 5—Canceller as a Stand-Alone Chip

FIG. 5 is an example block diagram illustrating a system for performing adaptive OOB interface cancellation embodied on a stand-alone chip 250 (i.e. a separate integrated circuit, such as a silicon chip).

The aggressor device 230B is shown as a typical arrangement of three chips 502, 504, and 506, with Tx antenna 312. For example, a cellular chip 502 typically comprises the standard cellular chip or chipset 302; a mixer chip 504 typically comprises the mixer 304, the LO 306, and the LPF 308; and an amplifier chip 506 typically comprises the PA 310 and the coupler 340. The amplifier chip 506 typically provides an output Tx signal to Tx antenna 312. The amplifier chip 506 also provides a coupler output terminal 508, which is driven by the output of the coupler 340. Alternatively, the coupler 340 may be independent of the amplifier chip 506, and may, for example, sample the Tx signal at the Tx antenna 312. The mixer chip 504 provides a LO output terminal 510, which is driven by the output of the LO 306.

The victim device 230A is shown as a typical arrangement of one Rx chip 520 with Rx antenna 320. For example, the Rx chip 520 typically comprises the BPF 322, the LNA 324, the mixer 326, the LO 328, the LPF 330, the AGC 332, the A/D converter 334, the digital delay line 336, and the communication protocol chip or chipset 338. The Rx chip 520 typically receives an input from Rx antenna 322. The Rx chip 520 provides a data signal output terminal 522, which is driven by the output of the digital delay line 336, and a data signal input terminal 524, which drives the input of the communication protocol chip or chipset 338.

In this exemplary embodiment, the canceller 250 is shown as a stand-alone chip 530. A person skilled in the art will appreciate, however, that the present disclosure may be realized where the canceller comprises either a single chip, or a set of chips and/or other discrete components. The canceller chip 530 comprises the filter 342, the buffer 344, the mixer 346, the LPF 348, the A/D converter 350, the adaptive filter 352, and the subtractor 354. The canceller chip 530 provides an aggressor input terminal 532, which drives the input of the filter 342, a LO input terminal 534, which drives the baseband translation input of the mixer 346, a victim input terminal 536, which drives one input of the subtractor 354, and a victim output terminal 538, which is driven by the output of the subtractor 354.

As shown, the coupler output terminal 508 of the amplifier chip 506 is communicatively coupled to the aggressor input terminal 532 of the canceller chip 530. The LO output terminal 510 of mixer chip 504 is communicatively coupled to the LO

input terminal 534 of the canceller chip 530. The data signal output terminal 522 of the Rx chip 520 is communicatively coupled to the victim input terminal 536 of the canceller chip 530. The victim output terminal 538 of the canceller chip 530 is communicatively coupled to the data signal input terminal 524 of the Rx chip 520.

In this exemplary embodiment, the canceller chip 530 operates according to the explanation of FIG. 3 to adaptively estimate and cancel the undesired cellular power radiated by the amplifier chip 506 and/or Tx antenna 312 from the receive path of Rx chip 520. Because the canceller chip 530 is separate from the various chips comprising the victim device 230A and the aggressor device 230B, this embodiment offers an advantage of independence from the manufacturers and vendors of those devices. Specifically, the canceller chip 530 can be altered and implemented based on the characteristics of a specific UE, without necessitating a design change in the victim device 230A or the aggressor device 230B. The separation of the canceller chip 530 from the victim device 230A and the aggressor device 230B in this embodiment also provides the advantage of flexibility in design layout of a UE.

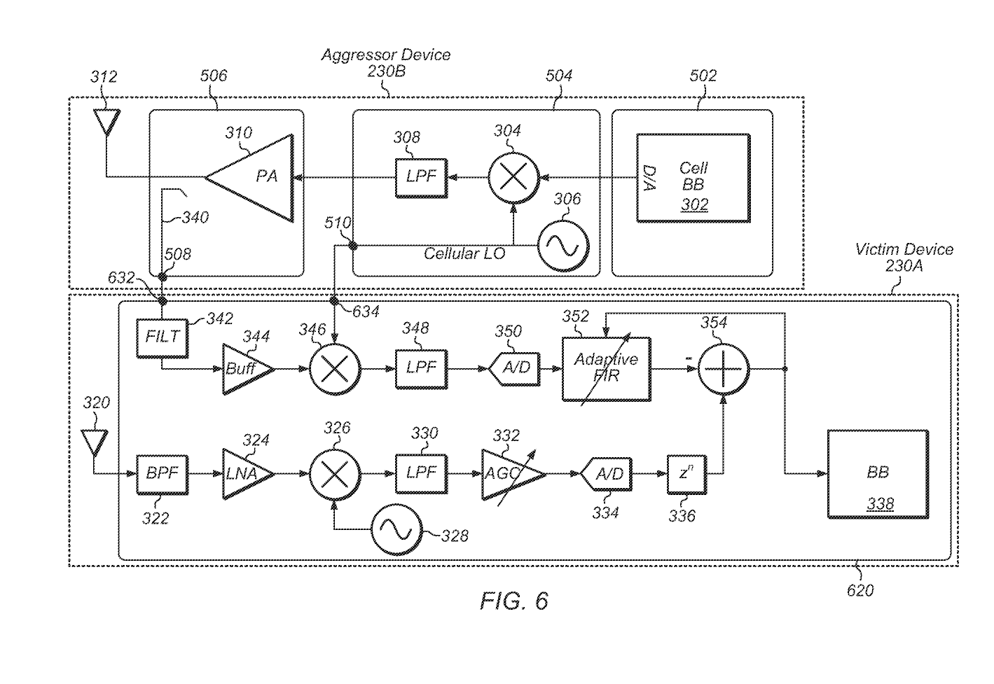

FIG. 6—Canceller Integrated with the Victim Device

FIG. 6 is an example block diagram illustrating a system for performing adaptive OOB interface cancellation integrated into a chip with a victim device 230A (i.e. the canceller and the victim device are collocated on a single integrated circuit, such as a silicon chip).

The aggressor device 230B is shown as in FIG. 5.

The canceller 250 and the victim device 230A are shown as an arrangement of one Rx chip 620 with Rx antenna 320. For example, the Rx chip 520 may comprise the BPF 322, the LNA 324, the mixer 326, the LO 328, the LPF 330, the AGC 332, the A/D converter 334, the digital delay line 336, the communication protocol chip or chipset 338, the filter 342, the buffer 344, the mixer 346, the LPF 348, the A/D converter 350, the adaptive filter 352, and the subtractor 354. The Rx chip 620 typically receives an input from Rx antenna 322. The Rx chip 620 provides an aggressor input terminal 632, which drives the input of the filter 342, a LO input terminal 634, which drives the baseband translation input of the mixer 346.

As shown, the coupler output terminal 508 of the amplifier chip 506 is communicatively coupled to the aggressor input terminal 632 of the Rx chip 620. The LO output terminal 510 of mixer chip 504 is communicatively coupled to the LO input terminal 634 of the Rx chip 620.

In this exemplary embodiment, the Rx chip 620 includes OOB interference cancellation circuitry that operates according to the explanation of FIG. 3 to adaptively estimate and cancel the undesired cellular power radiated by the amplifier chip 506 and/or Tx antenna 312 from the receive path of Rx chip 620. Because the Rx chip 530 is separate from the various chips comprising the aggressor device 230B, this embodiment offers an advantage of independence from the manufacturers and vendors of such devices. Specifically, the Rx chip 530 can be altered and implemented based on the characteristics of a specific UE, without necessitating a design change in the aggressor device 230B. The separation of the canceller chip 530 from the aggressor device 230B in this embodiment also provides the advantage of flexibility in design layout of a UE.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless user equipment (UE) device, comprising:
a first radio, configured to perform wireless communication within a first frequency range;
a second radio, configured to perform wireless communication within a second, different frequency range, wherein the second radio generates out-of-band noise within the first frequency range;
a processing element configured to cancel at least a portion of the out-of-band noise within the first frequency range from a receive path of the first radio.

2. The UE of claim 1, wherein the second radio is configured to wirelessly communicate with a cellular network.

3. The UE of claim 1, wherein the first frequency range is the Industrial, Scientific, and Medical (ISM) 2.4 GHz band.

4. The UE of claim 1, wherein the first radio is configured to wirelessly communicate according to at least one of:
a WiFi protocol;
a Bluetooth protocol;
a GPS protocol; and
a GNSS protocol.

5. The UE of claim 1, the processing element comprising:
a receiving element, configured to receive the out-of-band noise within the first frequency range;
a filter, configured to extract the out-of-band noise that is to be reduced;
a mixer, configured to translate the extracted out-of-band noise to baseband;
an analog-to-digital converter, configured to convert the translated out-of-band noise to a digital representation of the out-of-band noise;
an adaptive filter, configured to receive the digital representation of the out-of-band noise and a feedback signal, and to output a more accurate digital representation of the out-of-band noise; and
a subtractor, configured to receive the more accurate digital representation of the out-of-band noise from the adaptive filter and a digital representation of a communication signal from a first point in the receive path of the first radio, and to output the feedback signal to the adaptive filter and to a second point in the receive path of the first radio, wherein the feedback signal represents the result of subtracting the more accurate digital representation of the out-of-band noise from the digital representation of the communication signal.

6. The UE of claim 5, wherein the receiving element comprises a coupler configured to wirelessly receive the out-of-band noise within the first frequency range.

7. The UE of claim 5, wherein the receiving element comprises an input terminal configured to receive the out-of-band noise as a wired signal from the second radio.

8. The UE of claim 1, wherein the first radio and the processing element are located at least partially on the same chip.

9. The UE of claim 1, wherein the first radio and the processing element are located on separate chips.

10. The UE of claim 1, wherein the first radio and the second radio are located on separate chips.

11. A method of adaptively cancelling interference, comprising:
receiving, by a noise cancellation element within a user equipment (UE) device, an output signal generated by an aggressor wireless communication device within the UE device, wherein the output signal comprises out-of-band noise within first frequency range;
filtering the received output signal to extract a portion within the first frequency range;
mixing the extracted portion of the received output signal with a low-frequency oscillator signal from the aggressor wireless communication device to translate the extracted portion of the signal to baseband frequencies;
converting the translated signal to a digital representation;
adaptively filtering the digital representation using a feedback signal;
receiving a digital communication signal from a first point in a receive path of a victim wireless communication device within the UE device;
generating the feedback signal by subtracting the adaptively filtered digital representation from the digital communication signal; and
outputting the feedback signal to a second point in the receive path of the victim wireless communication device.

12. The method of claim 11, wherein the aggressor wireless communication device is not located on the same chip as either the noise cancellation element or the victim wireless communication device.

13. The method of claim 12, wherein the noise cancellation element and the victim wireless communication device are located on the same chip.

14. The method of claim 11, wherein the receiving an output signal comprises receiving a wired signal from the aggressor wireless communication device via an input terminal of the noise cancellation element.

15. A noise cancellation apparatus, comprising
a receiving element, configured to receive out-of-band noise within a first frequency range generated by an aggressor wireless communication device;
a filter, configured to extract the out-of-band noise;
a mixer, configured to translate the extracted out-of-band noise to baseband, wherein the mixer is driven by a low-frequency oscillator of the aggressor wireless communication device;
an analog-to-digital converter, configured to convert the translated out-of-band noise to a digital representation of the out-of-band noise;
an adaptive filter, configured to receive the digital representation of the out-of-band noise and a feedback signal, and to output a more accurate digital representation of the out-of-band noise; and
a subtractor, configured to receive the more accurate digital representation of the out-of-band noise from the adaptive filter and a digital representation of a communication signal from a first point in a receive path of a victim wireless communication device, and to output the feedback signal to the adaptive filter and to a second point in the receive path of the victim wireless communication device, wherein the feedback signal represents the result of subtracting the more accurate digital representation of the out-of-band noise from the digital representation of the communication signal.

16. The noise cancellation apparatus of claim 15, wherein the noise cancellation apparatus, the aggressor wireless communication device, and the victim wireless communication device are comprised within a user equipment (UE) device.

17. The noise cancellation apparatus of claim 16, wherein the aggressor wireless communication device is not located on the same chip as either the noise cancellation apparatus or the victim wireless communication device.

18. The method of claim 17, wherein the noise cancellation apparatus and the victim wireless communication device are located on the same chip.

19. The method of claim 17, wherein the receiving element comprises a coupler configured to wirelessly receive the out-of-band noise within the first frequency range.

20. The method of claim 17, wherein the receiving element comprises an input terminal configured to receive the out-of-band noise as a wired signal from the aggressor wireless communication device.
